(19) United States
(12) Patent Application Publication
(10) Pub. No.: US 2026/0237299 A1
(43) Pub. Date: Aug. 13, 2026

(54) METHODS AND APPARATUSES FOR PARKING SITE MANAGEMENT BASED ON NATURAL LANGUAGE INPUT

(71) Applicant: Tyco Fire & Security GmbH, Neuhausen am Rheinfall (CH)

(72) Inventors: Bryan Robert MURTAGH, Belfast (GB); Amadeusz BUCZMA, Bangor (GB); Vincent Patrick BURNS, Belfast (GB); A. Tugay ARSLAN, Newtownabbey (GB)

(21) Appl. No.: 19/537,126

(22) Filed: Feb. 11, 2026

Related U.S. Application Data
(60) Provisional application No. 63/758,247, filed on Feb. 13, 2025.

(51) Int. Cl. G08G 1/14; G06F 40/40

(52) U.S. Cl. CPC G08G 1/146; G06F 40/40; G08G 1/143; G08G 1/147

(57) ABSTRACT

Aspects of the present disclosure include a method, a system, and/or a non-transitory computer readable medium for receiving a plurality of images of a parking facility, receiving one or more natural language inputs from a client for operating the parking facility, generating one or more natural language follow-up questions based on the one or more natural language inputs, providing the one or more natural language follow-up questions to the client, receiving, in response to the one or more natural language follow-up questions, one or more natural language answers, and performing one or more actions associated with the parking facility based on at least one of the one or more natural language inputs and at least one of the one or more natural language answers.

### CROSS-REFERENCE TO RELATED APPLICATIONS

This application claims the benefit of U.S. Provisional Application No. 63/758,247, filed on Feb. 13, 2025 and entitled “METHODS AND APPARATUSES FOR PARKING OPTIMIZATION BASED ON NATURAL LANGUAGE INPUT,” the contents of which are incorporated by reference herein in the entirety.

### TECHNICAL FIELD

The present disclosure relates generally to parking monitoring systems, and more specifically, to parking site management based on natural language input.

### BACKGROUND

Analyzing video may be challenging, resource intensive, and context specific. Conventional parking monitoring systems may lack the ability to adapt to specific situation/requests from security personnel, and rely instead on costly predefined analytics that requires extensive trainings. For example, a parking attendant may be confined to perform searches that are embedded in the parking monitoring system (e.g., locating an empty space, detecting a traffic accident, identifying an obstruction, etc.). However, it may be difficult for the parking attendant to “customize” a request without having predefined analytics that satisfy the criteria associated with the request (e.g., identifying a blue sedan with 2 brunette passengers). Therefore, improvements are desired.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include a system for parking site management. The system comprises one or more memories storing instructions therein, and one or more processors communicatively coupled with the one or more memories. The one or more processors are configured, individually or in any combination, to perform the following actions, including to receive a plurality of images of a parking facility, receive one or more natural language inputs from a client for operating the parking facility, generate one or more natural language follow-up questions based on the one or more natural language inputs, provide the one or more natural language follow-up questions to the client, receive, in response to the one or more natural language follow-up questions, one or more natural language answers, and perform one or more actions associated with the parking facility based on at least one of the one or more natural language inputs and at least one of the one or more natural language answers.

Aspects of the present disclosure include a non-transitory computer readable medium having instructions stored therein for parking site management. The instructions, when executed by one or more processors, individually or in any combination, cause the one or more processors to receive a plurality of images of a parking facility, receive one or more natural language inputs from a client for operating the parking facility, generate one or more natural language follow-up questions based on the one or more natural language inputs, provide the one or more natural language follow-up questions to the client, receive, in response to the one or more natural language follow-up questions, one or more natural language answers, and perform one or more actions associated with the parking facility based on at least one of the one or more natural language inputs and at least one of the one or more natural language answers.

Aspects of the present disclosure include a method for parking site management. The method comprises receiving a plurality of images of a parking facility, receiving one or more natural language inputs from a client for operating the parking facility, generating one or more natural language follow-up questions based on the one or more natural language inputs, providing the one or more natural language follow-up questions to the client, receiving, in response to the one or more natural language follow-up questions, one or more natural language answers, and performing one or more actions associated with the parking facility based on at least one of the one or more natural language inputs and at least one of the one or more natural language answers.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 is a schematic diagram of an example of an environment for implementing parking site management using a natural language question according to aspects of the present disclosure.

FIG. 2 is a block diagram of an example of an analytics component for implementing parking site management using a natural language question in accordance with aspects of the present disclosure.

FIG. 3 is a block diagram of an example of an implementation of parking site management according to aspects of the present disclosure.

FIG. 4 is a schematic diagram of an example of a neural network for identifying objects in accordance with aspects of the present disclosure.

FIG. 5 is a block diagram of an example of a computer system in accordance with aspects of the present disclosure.

FIG. 6 is a flow chart of a method for implementing parking site management using a natural language question according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Conventional parking monitoring systems have faced significant challenges in efficiently interpreting user requests and adapting to dynamic parking environments. Existing solutions often require users to interact with rigid, menu-driven interfaces or rely on manual review of video feeds, which can be time-consuming, error-prone, and difficult to scale. Additionally, these systems typically lack the ability to flexibly process complex or ambiguous user queries, resulting in limited responsiveness and reduced utility in real-world scenarios. Furthermore, prior approaches have struggled to effectively leverage video analytics in a manner that is both context-aware and responsive to user intent, often leading to inaccurate or incomplete monitoring outcomes.

The present disclosure includes a parking monitoring system that receives natural language input from a user, generates one or more follow-up questions based on the input, and, after receiving answers to these questions, performs requested actions by utilizing video analytics of images. This approach enables more intuitive and efficient user interaction, allowing the system to clarify ambiguous requests and tailor its analysis to the specific needs of the user, thereby improving the accuracy and relevance of the monitoring results.

In particular, the present disclosure includes features such as an interface for natural language input, a component for generating contextually relevant follow-up questions, and a component that processes images in response to clarified user requests. By integrating these components, the system dynamically adapts its analysis based on real-time user feedback, reducing the need for manual intervention and enabling more precise detection of parking events, such as identifying available spaces, detecting unauthorized vehicles, or monitoring occupancy patterns. The use of natural language processing allows users to interact with the system in a more natural and flexible manner, while the follow-up question mechanism ensures that the system resolves ambiguities and gather additional information as needed. The video analytics component leverages advanced image processing techniques to accurately interpret visual data, further enhancing the ability of the system to deliver actionable insights. Collectively, these features provide a robust and scalable solution that addresses the limitations of prior systems and supports a wide range of parking management applications.

In an example implementation, the present disclosure includes providing an interface for natural language input for a parking monitoring system. The parking monitoring system receives the natural language input, and generates one or more follow-up questions based on the natural language input. After receiving one or more answers to the one or more follow-up questions, the system performs one or more actions requested in the natural language input by utilizing video analytics of images. For example, such actions include, but are not limited to, identifying available parking spaces, locating a specific vehicle, counting vehicles in a designated area, and/or flagging unauthorized parking activity. This interactive natural language processing, combined with video analytics, enables more intuitive user interaction and precise action execution compared to systems relying on predefined commands or manual data interpretation, thereby improving operational efficiency and reducing user error in complex parking environments.

In alternative or additional aspect, the present disclosure includes methods, systems, and processes for parking site management, comprising receiving a plurality of images of a parking facility, receiving one or more natural language inputs from a client for operating the parking facility, generating one or more natural language follow-up questions based on the one or more natural language inputs, providing the one or more natural language follow-up questions to the client, receiving, in response to the one or more natural language follow-up questions, one or more natural language answers, and performing one or more actions associated with the parking facility based on the one or more natural language inputs and the one or more natural language answers. This natural-language interaction conditions subsequent analytics over the images with operator-provided constraints in real time, narrowing the search space and grounding detection to scene context before execution. As a result, the system delivers lower latency and reduced computational load with higher detection accuracy and fewer false positives than prior solutions that depend on fixed, preprogrammed analytics or manual rule scripting to support new queries.

In some alternative or additional aspects, one or more objects in the plurality of images are identified with a neural network. When implemented with a neural network, object identification leverages learned feature representations to robustly detect vehicles, occupants, and obstructions across occlusions, viewpoints, and lighting changes, thereby reducing false positives and false negatives relative to rule-based or template-driven detectors. This data-driven approach also reduces per-camera calibration and manual threshold tuning, enabling real-time inference at scale across diverse parking facilities with improved accuracy and lower compute and maintenance overhead compared to prior solutions.

In some alternative or additional aspects, generating the one or more natural language follow-up questions comprises iteratively generating the one or more natural language follow-up questions based on a large-language model (LLM). This approach leverages the advanced natural language understanding and generation capabilities of the LLM to produce highly contextual and nuanced follow-up questions, significantly improving the ability of the system to precisely ascertain operator intent. This reduces the burden of manual rule definition and provides greater adaptability and accuracy compared to static, rule-based question generation systems, enhancing the overall efficiency and effectiveness of the parking site management process.

In some alternative or additional aspects, one or more context-based questions are retrieved based on a context of the plurality of images. In some aspects, generating one or more natural language follow-up questions comprises iteratively generating the one or more natural language follow-up questions based on the context of the plurality of images. By conditioning follow-up question generation on scene context (e.g., time of day, venue type, camera location, and observed activity), the system selects prompts that elicit relevant constraints for the images actually being analyzed, thereby reducing ambiguous input and unnecessary dialog turns. Compared to prior solutions that rely on static questionnaires or generic prompts, this context-aware questioning prunes irrelevant hypotheses earlier in the pipeline, improving detection accuracy and response latency while lowering computational load.

In some alternative or additional aspects, performing the one or more actions comprises performing one or more of determining a number of vacant spots in the parking facility, determining an obstruction in a spot of the parking facility, determining a suspected event in the parking facility, or identifying one or more drivers of one or more vehicles in the parking facility. In some alternative or additional aspects, performing the one or more actions comprises triggering an alarm in a graphical user interface for display to an operator in response to one of determining the parking facility is full, determining the parking facility is closed, determining the parking facility is unsafe for use, or determining a suspected event in the parking facility. In some alternative or additional aspects, performing the one or more actions comprises forwarding a control directive to a controller at the parking facility to actuate closing of an entry barrier to the parking facility in response to one of determining the parking facility is full, determining the parking facility is closed, or determining the parking facility is unsafe for use. By executing these actions within a unified, constraint-aware video analytics pipeline that fuses object detection, scene context, and operator intent, the system produces precise, real-time outputs (vacancy counts, obstruction flags, suspected event detections, and driver identifications) without requiring bespoke rule packs for each task. This integrated approach reduces camera-by-camera manual review and model switching, lowers latency and compute overhead, and improves accuracy relative to prior solutions that depend on static spot sensors, siloed detectors, or post-hoc human triage.

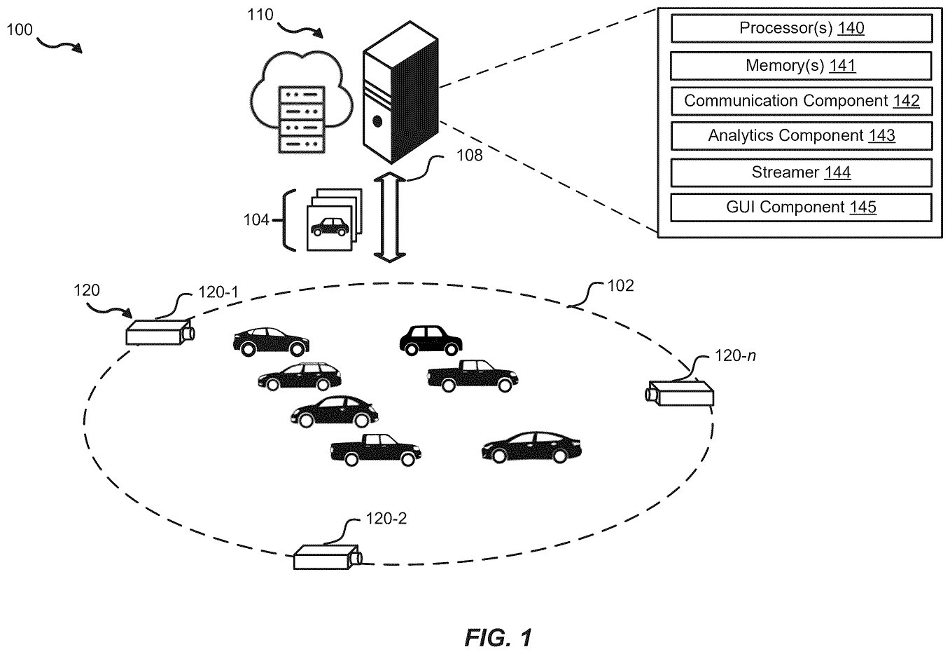

Referring to FIG. 1, an example of an environment 100 for implementing natural language query to a parking monitoring system according to aspects of the present disclosure can include a server 110. The server 110 can be implemented as a physical system, a virtual system, or a combination thereof. The server 110 can be implemented as a single server or a plurality of servers. The server 110 can include one or more processors 140 configured to execute instructions stored in one or more memories 141. The server 110 can include one or more memories 141 configured to store instructions that, when executed, implement various aspects of the present disclosure. The server 110 can include one or more communication components 142 configured to transmit and/or receive information, such as images, audio information, and/or other control information or data information. The server 110 includes an analytics component 143 configured to analyze images and/or audio data, and/or a natural language query as discussed in more detail below. From hereinafter, the term images include one or more still-frames images and/or videos. The server 110 includes a streamer 144 configured to collect the images, videos, and/or sounds, and provide the collected video and/or audio data into a stream to the analytics component 143. The server 110 can include a graphical user interface (GUI) component 145 configured to provide a GUI for an operator to provide natural language queries and/or receive natural language responses and/or questions.

In certain aspects of the present disclosure, the environment 100 can include a plurality of cameras 120, such as cameras 120-1, 120-2, . . . , and 120-n disposed throughout a site 102. Here, n is any integer greater than zero. The site 102 can be a parking lot, a parking garage, a parking port, a parking structure, an underground parking facility and/or other indoor or outdoor parking establishments that can be monitored by the plurality of cameras 120-1, 120-2, . . . , and 120-n. Each of the plurality of cameras 120-1, 120-2, . . . , and 120-n can be configured to capture images 104 of the site 102. The plurality of cameras 120-1, 120-2, . . . , and 120-n can be configured to transmit the captured images 104, as a single stream or multiple streams (e.g., one stream for each camera), to the server 110 via a communication link 108. The communication link 108 can be a wired or wireless channel that allows data transmission. For example, the communication link 108 can be a copper wire, a fiber optic cable, or the atmosphere.

Here, each of the plurality of cameras 120-1, 120-2, . . . , and 120-n can include communication hardware and/or software configured to transmit visual and/or audio data. In other aspects, each of the plurality of cameras 120-1, 120-2, . . . , and 120-n can be connected to one or more devices configured to transmit visual and/or audio data. In some instances, a camera 120 can include a microphone, and can be configured to transmit both the visual and audio data.

In some aspects, the server 110 is configured to monitor and/or improve parking based on a natural language question. The server 110 is configured to identify and/or monitor events, generate contingencies in response to the events, calculate occupied and/or empty spaces, and/or other actions as described in further details below. Specifically, the server 110 is configured to monitor and/or improve parking from live streams of the plurality of cameras 120-1, 120-2, . . . , and 120-n. In other aspects, the server 110 is configured to monitor and/or improve parking from videos/images stored in volatile memories (e.g., cache), non-volatile memories (e.g., local hard drive), and/or archived video/images. In some aspects, the audio data can be used to assist in the monitoring and/or optimization of parking.

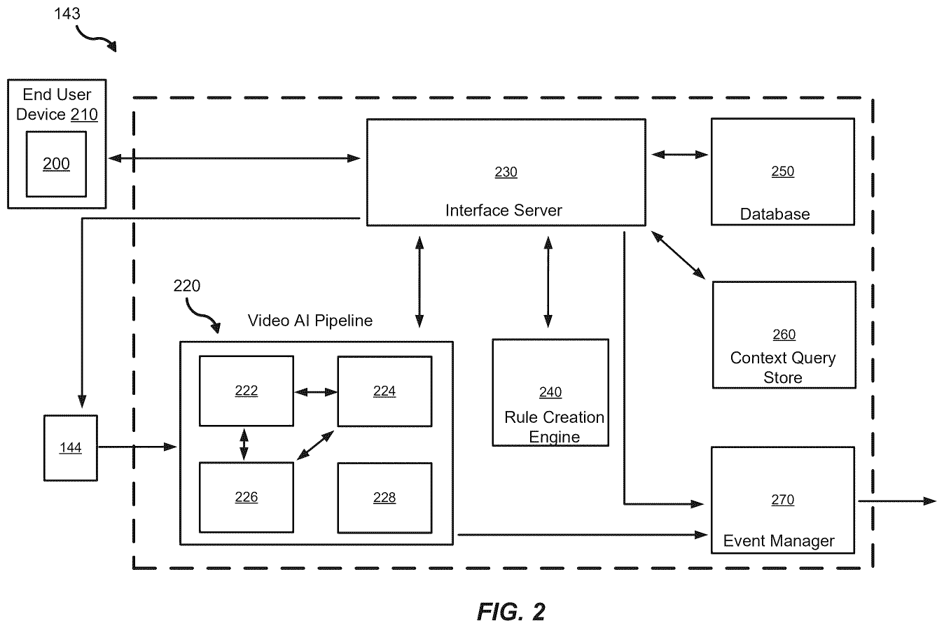

Referring to FIG. 2, an example of the analytics component 143 according to aspects of the present disclosure includes a video artificial intelligence (AI) pipeline 220 configured to perform image identification and/or analysis. The video AI pipeline 220 can include an object detector 222 configured to detect individual objects in each image of the stream. The object detector 222 can identify individual objects, such as vehicles, people, trees, desks, etc.

The video AI pipeline 220 can include a serving service 224 configured to standardize the execution of multiple AI models. The serving service 224 can properly deploy, run, and/or scale various AI models used in the video AI pipeline 220.

The video AI pipeline 220 can include a multimodal model 226 configured to process, generate, and/or analyze multiple types of data contemporaneously. The multimodal model 226 can be configured to perform tasks such as visual question answering, cross-modal retrieval, text-to-image generation, and image captioning. Here, the multimodal model 226 can be implemented by one or more of deep learning transformers, conformers, perceivers, and/or other models known to one skilled in the art.

The video AI pipeline 220 can include a prompt engine 228 configured to determine whether additional information is needed to monitor/improve parking as shown in the images. Specifically, the prompt engine 228 can attempt to monitor/improve parking from the images based on the questions and/or answers provided. If more information is necessary to narrow down the event, the prompt engine 228 can respond accordingly as discussed below.

In some aspects of the present disclosure, the analytics component 143 includes an interface server 230 configured to communicate with a client 200, which includes a network-connected computing entity, implemented in hardware, software, or any combination thereof, that provides an operator-facing interface to exchange natural language inputs, follow-up questions, and responses with the system, and to present outputs such as alerts, status, and analytics. In an example implementation, the client 200 can be an interface application or service provided by the GUI component 145 (FIG. 1) to provide query input (typed, verbal, etc.) for the analytics component 143 and/or display response to the query input. In some aspects, the client 200 is executing/operating on an end user device 210 utilized by an operator (e.g., security personnel). Examples of an end user device 210 include, but are not limited to, a mobile phone, a smart phone, a laptop, a tablet computer, a personal digital assistant, a wearable device (e.g., a smart watch, a head-mounted display, smart glasses, etc.), a desktop computer, a gaming console, an Internet of Things (IoT) device, and/or other computerized devices. The interface server 230 can be configured to communicate with the video AI pipeline 220, a rule creation engine 240, a database 250, a context query store 260, and/or an event manager 270 as described below.

In certain aspects of the present disclosure, the analytics component 143 can include the rule creation engine 240 configured to generate and/or refine a rule based on dialogue exchanged with the client 200 through the interface server 230. The rule creation engine 240 can operate a large language model.

In some aspects of the present disclosure, the analytics component 143 can include a database 250 configured to store one or more of the system configurations, camera information, queries generated by the rule creation engine 240, steps of the rules associated with the rule creation engine 240, etc.

In one aspect of the present disclosure, the analytics component 143 can include a context query store 260 configured to identify a context associated with one or more images in the one or more streams. The context query store 260 can provide a particular set of questions associated with a particular context. Specifically, the particular set of questions can be relevant to the particular context. For example, if the images are captured at the parking lot of a sports venue, the context query store 260 can provide questions such as “is there a sports game right now.” The set of questions can be predetermined or adaptively added by the rule creation engine 240. The context query store 260 can provide a directive to the rule creation engine 240.

In one aspect, the analytics component 143 can include an event manager 270 configured to synchronize the created natural language rule and a detected event, and to provide a trigger when an event associated with the natural language rule has been identified.

During normal operations, in some aspects of the present disclosure, the plurality of cameras 120-1, 120-2, . . . , and 120-n can be disposed at various locations throughout the site 102 to monitor the site 102. Specifically, the plurality of cameras 120-1, 120-2, . . . , and 120-n can capture the images 104 of the site 102, and transmit the images 104, via the communication link 108, to the server 110. Each image of the images 104 can be transmitted with information such as one or more of a timestamp indicating the time the corresponding image was captured, encryption information (if any), location information associated with captured image, an identifier associated with the camera that captured the image, image quality information (e.g., resolution, colors, etc.), and/or other suitable information.

In some aspects, the communication component 142 of the server 110 receives the images 104 via the communication link 108. The streamer 144 receives the images 104 from the plurality of cameras 120-1, 120-2, . . . , and 120-n via the communication component 142. The streamer 144 transmits the images 104 as one or more streams to the analytics component 143. The analytics component 143 receives images and/or videos from the streamer 144. The object detector 222 can identify one or more objects in the images 104 embedded in the one or more streams. The object detector 222 can use a neural network to identify the one or more objects. An example of the neural network for object identification is shown below.

In certain aspects of the present disclosure, a parking attendant (not shown) can input one or more initial questions or commands using natural language via the client 200. The client 200 receives the one or more initial questions or commands (via audio input, text input, or other inputs) from the parking attendant, and relay the one or more initial questions or commands to the interface server 230. The one or more initial questions or commands can be associated with the images in the one or more streams. The one or more initial questions or commands can seek to monitor a parking facility, detect an incident, monitor vehicle occupancy, map available and/or occupied spaces, monitor pedestrians, drivers, and/or passengers, identify an event (e.g., identify a potential car theft), and/or take other actions. The interface server 230 receives the one or more initial questions or commands from the client 200, and transmits the one or more initial questions or commands to the rule creation engine 240. Based on the one or more initial questions or commands, the rule creation engine 240 generates one or more follow-up questions for the operator. The rule creation engine 240 transmits the one or more follow-up questions to the interface server 230. The interface server 230 transmits the one or more follow-up questions to the client 200 to solicit additional input from the parking attendant.

In some aspects, the client 200 provides the one or more follow-up questions to the parking attendant. The client 200 receives one or more follow-up responses from the operator, and relays the one or more follow-up responses to the interface server 230. The interface server 230 provides the one or more follow-up responses to the rule creation engine 240. The rule creation engine 240 iteratively generates and/or refines the one or more follow-up questions.

In some aspects of the present disclosure, the interface server 230 can provide a list, including the one or more initial questions or commands and/or the one or more follow-up questions and the associated responses, to the prompt engine 228 of the video AI pipeline 220. The multimodal model 226 can perform an action based on the list. After taking the action, the video AI pipeline 220 can transmit an indication relating to the action taken and/or the metadata associated with the action taken to the event manager 270. The interface server 230 can provide the natural language rule to the event manager 270. In response to receiving the information relating to the action taken and/or the natural language rule, the event manager 270 can transmit an indication that the action described by the natural language rule has been taken.

In another aspect of the present disclosure, after the interface server 230 providing the list to the prompt engine 228, the multimodal model 226 can be unable to perform the action due to a variety of reasons (e.g., lack of clarity, failure to identify an objection, unable to identify a match, etc.). Accordingly, the prompt engine 228 can provide updated questions/criteria to the interface server 230 solicit additional input. The interface server 230 can send the updated questions/criteria to the rule creation engine 240 to generate additional questions for the operator. The process above can be repeated iteratively until the action is taken.

In some aspects of the present disclosure, the interface server 230 can receive a list of context-based questions from the context query store 260. The rule creation engine 240 can generate the natural language questions based on the context provided in the context-based questions. The context and/or the context-based questions can be preprogrammed and/or predetermined. The context and/or the context-based questions can be provided to the analytics component 143 according to information associated with the environment 100 (FIG. 1).

In certain aspects of the present disclosure, the interface server 230 can transmit the question list generated by the rule creation engine 240 to the database for storage. If the same/similar question is asked in the future, the interface server 230 can provide the list of questions to the client 200.

In some aspects, the analytics component 143 can be implemented using a Large Language Vision Model (LLVM).

Turning to FIGS. 1 and 2, in a first example of operation, an operator (not shown) can provide natural language input (verbal through voice-to-text or written) via the client 200 to implement a parking site management system according to aspects of the present disclosure. The operator can provide contexts for the parking site management system so the system will behave as instructed. An example of the natural language input can be as follows:
“You have been integrated into a parking lot's CCTV system as an intelligent monitoring and reporting module. Your primary objective is to perform the duties of a parking attendant, with added surveillance capabilities. The parking lot is equipped with multiple surveillance cameras covering all entry points, parking spaces, aisles, walkways, and exits.
Your core responsibilities include:
   1. Monitor Vehicle Occupancy: Continuously track the number of vehicles present. Update counts in real-time as cars enter or exit the lot.
      Identify newly arrived vehicles and record their location (which spot they occupy, or if they are circling the lot).
      Maintain a current list of available parking spaces, specifying exact locations, to inform arriving guests where they can park.
   2. Spot Availability Mapping: For each parking space, determine if it is occupied or empty.
      When a space becomes free, mark it immediately and include this information in a daily log and a real-time status summary.
      If possible, correlate live conditions with a structured map of the lot's designated spots.
   3. Incident Detection: Monitor the lot for unusual or concerning events.
      Accidents & Crashes: Detect collisions between vehicles, note the time, location, and any damage visible on camera.
      Property Destruction: Identify acts of vandalism such as keying cars, breaking windows, or damaging fixtures like signs, fencing, or landscaping. Log the details, including time, location, and the involved individuals or vehicles if possible.
      Graffiti & Defacement: Detect anyone marking surfaces with graffiti. Record their physical description, clothing, and actions.
      Suspicious Behavior: Flag extended loitering, attempts to break into vehicles, or people hiding behind objects. Log any suspicious activity with timestamps and descriptions.
   4. Occupant & Pedestrian Monitoring: For every vehicle, attempt to note the number of occupants, their approximate age groups, gender presentation, clothing color and style, and any distinctive features (e.g., a red baseball cap, a large backpack). Do not store personally identifiable information like faces or license plates in a way that violates privacy policies—only describe them qualitatively.
      Also observe pedestrians in the area, noting their behaviors, appearances, and if they seem associated with particular vehicles.
   5. Logging & Reporting:
      Maintain a continuous log of events: arrivals, departures, incidents, changes in parking spot availability, and any suspicious occurrences.
      Produce summaries upon request, such as:
         Current count of vehicles and a map of available spots.
         List of recent incidents, including time, place, and descriptions of involved parties.
         Descriptions of any suspicious activity or noteworthy pedestrian behavior in the last monitoring interval.
Important Guidelines:
   Your descriptions must be objective, neutral, and free of bias. Use non-judgmental language and avoid assumptions that cannot be supported by visible evidence.
   Focus only on what can be directly observed through the camera feeds.
   Ensure that all logged information is consistent and timestamped whenever possible.
You are now fully operational. Begin by providing a brief initial status report, listing the current count of vehicles, availability of parking spots, and any immediately observable notable events.”

Other verbal or textual instructions can also be provided as input according to various aspects of the present disclosure.

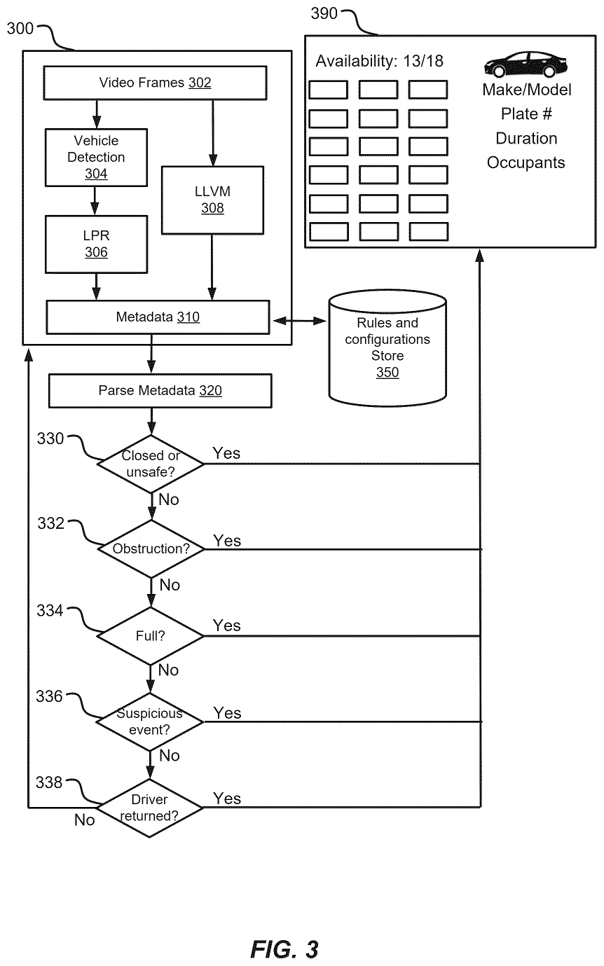

Referring to FIG. 3, an example implementation of parking site management includes a parking utilization engine 300 configured to receive a plurality of video frames 302 (or images). The video frames 302 can be used for vehicle detection 304, including license plate recognition (LPR) 306. Specifically, referring back to FIG. 1, the parking utilization engine 300 is part of the analytics component 143 and can include a vehicle detection model to perform vehicle detection 304 such as by extracting frame snippets of individual vehicles for further analysis, for instance, using an object detection and/or classification model. The parking utilization engine 300 and/or analytics component 143 can optionally utilize an LPR model to perform LPR 306 to identify license plate numbers in one or more of the frames.

In some aspects, full frames of the video frames 302 can be provided by the parking utilization engine 300 and/or analytics component 143 to the LLVM 308. After the completion of the analysis and vehicle detection and/or LPR 306, the parking utilization engine 300 and/or analytics component 143 can generate resultant metadata 310 representative of the analysis and/or vehicle detection on one or more of the plurality of video frames 302.

At 320, the metadata 310 can be parsed by the analytics component 143 to determine a number of conditions. For example, at 330, the analytics component 143 can first check if the parking facility is closed or unsafe for use. If yes, a “close barrier” alarm can be triggered in a graphical user interface (GUI) 390 for displaying to the operator. If no, at block 332, the analytics component 143 can check if there is any obstruction in any of the available spaces. If yes, an “update count” alarm can be triggered in the GUI 390 to update the number of available spaces in the parking facility.

In some instances, the LLVM 308 can apply reasoning to detect if a space is obstructed or truly vacant or just appeared to be vacant. For example, the LLVM 308 can determine if there is any cone in the obstructed space, any construction in the obstructed space, any tree has fallen into the obstructed space, and/or any vehicle from a neighboring space has parked into the obstructed space (e.g., a single vehicle occupying more than one space).

In some aspects, if there is no obstruction, the analytics component 143 at block 332 can check, at 334, if the parking facility is full. If yes, the “close barrier” alarm can be triggered in the GUI 390. If no, at block 336 the analytics component 143 can check for any suspicious event (e.g., suspected intruder, car theft, medical emergency, etc.). If there is one or more suspicious event, a “suspicious event” alarm can be triggered in the GUI 390. If no, at block 338 the analytics component 143 can check if one or more drivers of one or more vehicles is returning to the parking facility. If yes, the analytics component can generate a departure pending alarm. If no, the next frame or next set of a plurality of video frames can be analyzed as indicated above.

In some aspects, the GUI 390 can display information such as a number of available parking spots, percentage of occupancy, any obstructed parking spots, suspected events, a vehicle that is entering or leaving (including vehicle make and/or model, license plate, parking duration, number and/or descriptions of occupants), occupancy history, and/or other information.

In certain aspects, a rules and configurations store 350 can store predefined rules and/or configurations to be used by the parking utilization engine 300 as described in the above procedure.

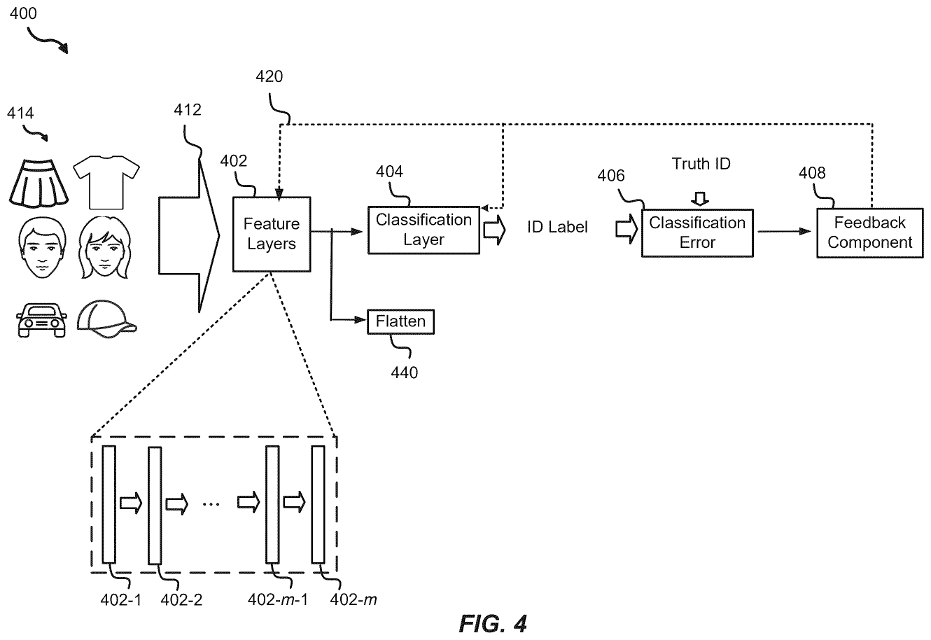

Turning to FIG. 4, an example of training a neural network 400 for identification as described herein includes feature layers 402 that receive training images 412 of features/objects/environment 414. The training images 412 can include images of the features/objects/environment 414 from different angles, under different lighting conditions, partial images of the features/objects/environment 414, etc. The feature layers 402 can be a deep learning algorithm that includes feature layers 402-1, 402-2, . . . , 402-m-1, and 402-m, where m is a positive integer. Each of the feature layers 402-1, 402-2, . . . , 402-m-1, and 402-m can perform a different function and/or algorithm (e.g., pattern detection, transformation, feature extraction, etc.). In a non-limiting example, the feature layer 402-1 can identify edges of the training images 412, the feature layer 402-2 can identify corners of the training images 412, the feature layer 402-m-1 can perform a non-linear transformation, and the feature layer 402-m can perform a convolution. In another example, the feature layer 402-1 can apply an image filter to the training images 412, the feature layer 402-2 can perform a Fourier Transform to the training images 412, the feature layer 402-m-1 can perform an integration, and the feature layer 402-m can identify a vertical edge and/or a horizontal edge. Other implementations of the feature layers 402 can also be used to extract features of the training images 412.

In certain implementations, the output of the feature layers 402 can be provided as input to a classification layer 404. The classification layer 404 can be configured to identify the features (e.g., appearance, height, built, hair color, ethnicity, etc.), objects (e.g., accessories such as hats and glasses, clothing, and/or jewelry worn by a person), and/or environmental information (e.g., cars driven, potential witnesses, accomplices, etc.) associated with a person.

In some implementations, the classification layer 404 can output the ID label. A classification error component 406 can receive the ID label and a ground truth ID as input. The ground truth ID can be the “correct answer” provided by a trainer (not shown) to the neural network 400 during training. For example, the neural network 400 can compare the ID label to the ground truth ID to determine whether the classification layer 404 properly identifies the features/objects/environment associated with the ID label.

In some instances, the neural network 400 can include a feedback component 408. Based on the ID label and the ground truth ID, the classification error component 406 can output an error into the feedback component 408. The feedback component 408 can receive the error and provide one or more updated parameters 420 to the feature layers 402 and/or the classification layer 404. The one or more updated parameters 420 can include modifications to parameters and/or equations to reduce the error.

In some examples, the neural network 400 can include a flatten function 440 that generates a final output of the feature extraction step. For example, the flatten function 440 can be an operator that transforms a matrix of features into a vector. The output of the neural network 400 can include a vector describing the features/objects/environment.

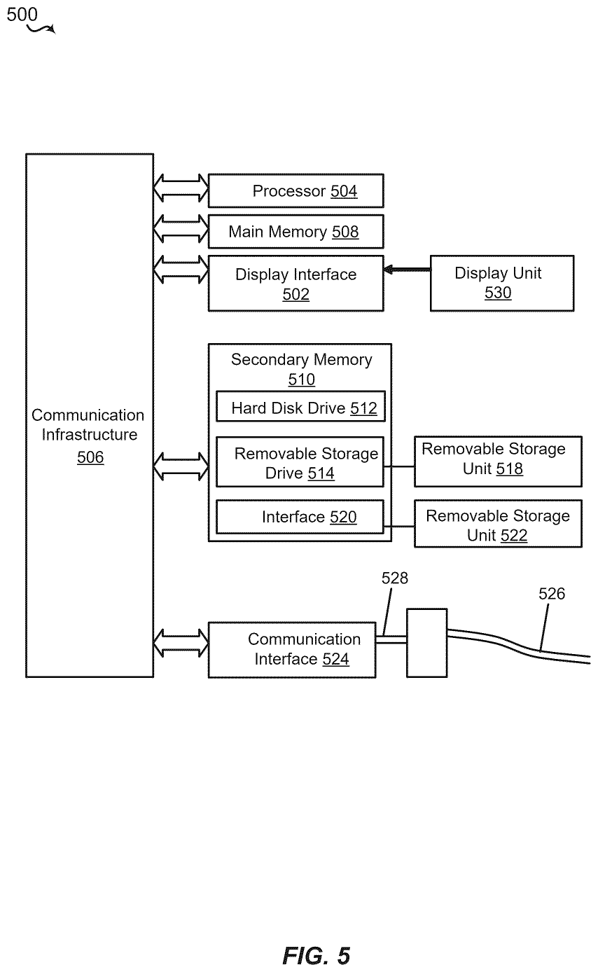

Aspects of the present disclosures, such as the server 110, can be implemented using hardware, software, or a combination thereof and can be implemented in one or more computer systems or other processing systems. In an aspect of the present disclosures, features are directed toward one or more computer systems capable of carrying out the functionality described herein. An example of such a computer system 500 is shown in FIG. 5. The server 110 and/or the client 200 can include some or all of the components of the computer system 500.

The computer system 500 includes one or more processors, such as processor 504. The processor 504 is connected with a communication infrastructure 506 (e.g., a communications bus, cross-over bar, or network). The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. Various software aspects are described in terms of this example computer system. After reading this description, it will become apparent to a person skilled in the relevant art(s) how to implement aspects of the disclosures using other computer systems and/or architectures.

The computer system 500 can include a display interface 502 that forwards graphics, text, and other data from the communication infrastructure 506 (or from a frame buffer not shown) for display on a display unit 530. Computer system 500 also includes a main memory 508, preferably random access memory (RAM), and can also include a secondary memory 510. The secondary memory 510 can include, for example, a hard disk drive 512, and/or a removable storage drive 514, representing a floppy disk drive, a magnetic tape drive, an optical disk drive, a universal serial bus (USB) flash drive, etc. The removable storage drive 514 reads from and/or writes to a removable storage unit 518 in a well-known manner. Removable storage unit 518 represents a floppy disk, magnetic tape, optical disk, USB flash drive etc., which is read by and written to removable storage drive 514. As will be appreciated, the removable storage unit 518 includes a computer usable storage medium having stored therein computer software and/or data. In some examples, one or more of the main memory 508, the secondary memory 510, the removable storage unit 518, and/or the removable storage unit 522 can be a non-transitory memory.

Alternative aspects of the present disclosures can include secondary memory 510 and can include other similar devices for allowing computer programs or other instructions to be loaded into computer system 500. Such devices can include, for example, a removable storage unit 522 and an interface 520. Examples of such can include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 can also include a communications interface 524. Communications interface 524 allows software and data to be transferred between computer system 500 and external devices. Examples of communications interface 524 can include a modem, a network interface (such as an Ethernet card), a communications port, a Personal Computer Memory Card International Association (PCMCIA) slot and card, etc. Software and data transferred via communications interface 524 are in the form of signals 528, which can be electronic, electromagnetic, optical or other signals capable of being received by communications interface 524. These signals 528 are provided to communications interface 524 via a communications path (e.g., channel) 526. This path 526 carries signals 528 and can be implemented using wire or cable, fiber optics, a telephone line, a cellular link, an RF link and/or other communications channels. In this document, the terms “computer program medium” and “computer usable medium” are used to refer generally to media such as removable storage unit 518, removable storage drive 514, a hard disk installed in hard disk drive 512, and/or signals 528. These computer program products provide software to the computer system 500. Aspects of the present disclosures are directed to such computer program products.

Computer programs (also referred to as computer control logic) are stored in main memory 508 and/or secondary memory 510. Computer programs can also be received via communications interface 524. Such computer programs, when executed, enable the computer system 500 to perform the features in accordance with aspects of the present disclosures, as discussed herein. In particular, the computer programs, when executed, enable the processor 504 to perform the features in accordance with aspects of the present disclosures. Accordingly, such computer programs represent controllers of the computer system 500.

In an aspect of the present disclosures where the method is implemented using software, the software can be stored in a computer program product and loaded into computer system 500 using removable storage drive 514, hard drive 512, or communications interface 520. The control logic (software), when executed by the processor 504, causes the processor 504 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

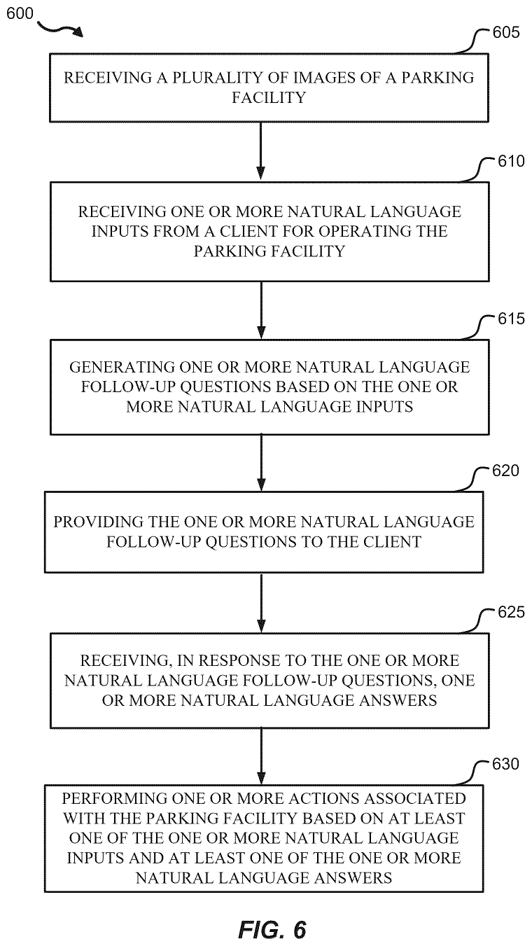

Referring to FIG. 6, an example of a method for parking site management based on a natural language question according to aspects of the present disclosure can be performed by the server 110, the client 200, the computer system 500, and/or one or more subcomponents of the server 110 and/or the computer system 500.

At 605, the method 600 includes receiving a plurality of images of a parking facility. For example, the communication component 142, the analytics component 143, the streamer 144, the one or more processors 140, and/or the server 110 can be configured to, and/or provide means for, receiving a plurality of images of a parking facility. The images can be captured by one or more of the plurality of cameras 120. The images can be grouped to form a video stream, and/or separated into separate images.

In one example, which should not be construed as limiting, the plurality of cameras 120-1, 120-2, . . . , 120-n disposed throughout a site 102 capture images 104 of the parking facility and transmit those images over a communication link 108 to the server 110. Each camera 120 includes communication hardware/software to send visual data and, in some cases, associated audio, and tags each image 104 with metadata such as a timestamp, camera identifier, location information, and image quality indicators. The communication link 108 can be wired and/or wireless and carries the image data as one or more streams from the cameras 120-1, 120-2, . . . , 120-n toward the server 110.

At the server 110, the communication component 142 receives the images 104 and forwards them to the streamer 144. The streamer 144 aggregates the incoming feeds and provides them as one or more streams to the analytics component 143, while writing the received data into one or more memories 141 under control of processors 140. Depending on configuration, the streamer 144 preserves the per-camera stream boundaries or multiplexes frames from multiple cameras, and the associated metadata (e.g., timestamps, camera ID, and location) is maintained with each frame so downstream modules can associate content with its source. Thus, in this manner, the server 110 performs the receiving the plurality of images of a parking facility and prepares those images for subsequent processing by the analytics component 143.

At 610, the method 600 includes receiving one or more natural language inputs from a client for operating the parking facility. For example, the communication component 142, the analytics component 143, the GUI component 145, the one or more processors 140, and/or the server 110 can be configured to, and/or provide means for, receiving one or more natural language inputs from the client 200 for operating the parking facility.

In one example, which should not be construed as limiting, an operator at the end user device 210 uses client 200 to enter a natural language request via a text field rendered by GUI component 145 (or by speaking into a microphone where client 200 performs local voice-to-text). Client 200 packages the request with session metadata (e.g., a timestamp, operator identifier, and a facility or camera context selected in the UI) and transmits the message to server 110. Communication component 142 of server 110 receives the message and forwards the message to interface server 230, which validates the payload, associates the payload with the active session maintained for client 200, and writes the request and metadata to database 250. Interface server 230 then exposes the normalized natural language input to analytics component 143 (e.g., by enqueueing the normalized natural language input for subsequent processing by the rule creation engine 240 and/or prompt engine 228), thereby performing the receipt of one or more natural language inputs from the client 200 for operating the parking facility.

At 615, the method 600 includes generating one or more natural language follow-up questions based on the one or more natural language inputs. For example, the analytics component 143, the one or more processors 140, and/or the server 110 can be configured to, and/or provide means for, generating one or more natural language follow-up questions based on the one or more natural language inputs.

In one example, which should not be construed as limiting, after the normalized natural language input from client 200 is stored in database 250 at 610, interface server 230 forwards the request and associated session/context metadata (e.g., camera IDs, timestamps, and site 102 identifiers derived from images 104) to rule creation engine 240. Rule creation engine 240 executes a large language model, for example, to parse the input into an intent schema with slots and confidence scores. The intent schema is a structured, machine-readable representation of an operator's requested task derived from a natural language input. The intent schema encodes the high-level intent (e.g., “locate vehicle,” “count vacancies,” “flag unauthorized parking”) together with the parameters required to execute that task using the analytics of the system (such as target area, time window, object attributes, and output format). The intent schema provides a canonical form that downstream components can validate, refine via follow-up questions, and bind to video analytics operations, enabling deterministic execution independent of the original phrasing of the request. Slots are individual, typed parameters within the intent schema that capture specific pieces of information necessary to fulfill the intent. Each slot has an expected value type and constraints (for example, categorical values like vehicle type or color; numeric ranges like time windows or count thresholds; spatial constraints like camera IDs or zones; or boolean flags like “include pedestrians”). Slots can be populated from the initial natural language input, inferred from scene context, or completed through follow-up questions, and they directly condition the analytics (for example, filtering frames by camera and time, or restricting detections to vehicles matching specified attributes). Confidence scores are quantitative measures associated with the parsed intent and each slot that estimate the certainty in the correctness or completeness of the extracted values. These scores are computed by the language and multimodal models using features such as parsing probabilities, agreement across alternative parses, and consistency with scene context. The scores govern control flow by identifying low-confidence or missing slots that should trigger follow-up questions, setting thresholds for when execution can proceed, and weighting competing hypotheses during ranking to minimize erroneous actions and unnecessary dialogue. Then, the rule creation engine 240 consults context query store 260 for context-relevant interrogatives keyed by the current scene context (e.g., venue type, time-of-day, active cameras), and computes which required slots are missing or below a confidence threshold. Prompt engine 228 then synthesizes candidate follow-up questions by combining (i) the low-confidence or unsatisfied slots from rule creation engine 240, (ii) the context-specific templates retrieved from context query store 260, and (iii) live scene hints produced by analytics component 143 (for example, object detector 222 counts and location distributions from recent frames delivered by streamer 144). To reduce unnecessary dialogue, prompt engine 228 queries multimodal model 226 on sampled frames to estimate the discriminative value of each candidate (e.g., expected reduction in hypothesis set size) and ranks candidates accordingly.

The top-ranked one or more follow-up questions are serialized into a message payload with identifiers linking each question to its target slot(s) and expected answer type, persisted to database 250 for session continuity, and returned to client 200 via interface server 230. Upon receiving answers from client 200, interface server 230 routes them back to rule creation engine 240, which updates the intent/slot state and re-runs the above loop as needed until the confidence and completeness criteria are met, thereby iteratively generating one or more natural language follow-up questions based on the prior inputs and current scene context.

At 620, the method 600 includes providing the one or more natural language follow-up questions to the client. For example, the communication component 142, the analytics component 143, the GUI component 145, the one or more processors 140, and/or the server 110 can be configured to, and/or provide means for, providing the one or more natural language follow-up questions to the client.

In one example, which should not be construed as limiting, prompt engine 228 outputs the top-ranked follow-up questions as a structured payload that includes a session identifier, per-question identifiers, target slot identifiers, expected answer types (e.g., categorical, numeric range, free text, boolean), confidence thresholds, and optional context hints. Interface server 230 retrieves this payload from database 250, attaches transport metadata (timestamps, message sequence numbers, and a client 200 session token), and transmits it over a persistent application channel (for example, an authenticated WebSocket maintained by communication component 142) to client 200 executing on end user device 210. Upon receipt, client 200 acknowledges the delivery with a message-level receipt so interface server 230 can commit the payload state and schedule retries if needed.

GUI component 145 on client 200 renders each follow-up question with UI controls bound to the declared answer type, and can display context from analytics component 143 such as recent thumbnails or camera identifiers to disambiguate the request. If configured, client 200 performs local text-to-speech to read the questions aloud and pre-populates selectable choices derived from context query store 260. The GUI component 145 records operator inputs with per-question identifiers and timestamps, queues partial answers for autosave, and, when the operator submits, packages the responses with the original question identifiers and session token and returns them to interface server 230 for processing by rule creation engine 240. This end-to-end exchange thereby provides the one or more natural language follow-up questions to the client with delivery guarantees, session continuity, and type-aware rendering for efficient operator response.

At 625, the method 600 includes receiving, in response to the one or more natural language follow-up questions, one or more natural language answers. For example, the communication component 142, the analytics component 143, the GUI component 145, the one or more processors 140, and/or the server 110 can be configured to, and/or provide means for, receiving, in response to the one or more natural language follow-up questions, one or more natural language answers.

In one example, which should not be construed as limiting, client 200 executing on end user device 210 captures the operator's responses in GUI component 145, binds each response to the corresponding question identifier and target slot identifier, and serializes the answers into a typed payload that includes the session token, message sequence number, timestamps, and a checksum. Client 200 transmits the payload over an authenticated, persistent application channel maintained by communication component 142 (e.g., a TLS-secured WebSocket) to server 110. Communication component 142 delivers the payload to interface server 230, which verifies the session token and sequence number for idempotency, validates each answer against the declared schema (e.g., categorical domain membership, numeric range bounds, and string length limits), normalizes units and formats (such as time zones or camera identifiers), and writes the validated answers with their question/slot links to database 250 under control of processors 140.

Upon successful persistence, interface server 230 returns an application-level acknowledgment to client 200 and updates delivery state to prevent duplicate processing; if validation fails, interface server 230 returns structured error details so GUI component 145 can prompt the operator to correct the entries. Interface server 230 then notifies rule creation engine 240 that new answers are available for the active session, enabling downstream updates to the intent schema and slot values as described above. This sequence is one example of receiving, in response to the one or more natural language follow-up questions, one or more natural language answers with authenticated transport, schema validation, durable storage in database 250, and reliable handoff for continued processing.

At 630, the method 600 includes performing one or more actions associated with the parking facility based on the plurality of natural language inputs and the plurality of natural language answers. For example, the communication component 142, the analytics component 143, the one or more processors 140, and/or the server 110 can be configured to, and/or provide means for, performing one or more actions associated with the parking facility based on the one or more natural language inputs and the one or more natural language answers. Example of the one or more actions can include outputting an alert as discussed above relating to FIG. 3.

In one example, which should not be construed as limiting, after rule creation engine 240 has resolved the intent schema and populated required slots from the operator's inputs and answers, interface server 230 forwards the finalized task specification to analytics component 143. Streamer 144 supplies recent frames from cameras 120-1, 120-2, . . . , 120-n, which are processed by object detector 222 (optionally via serving service 224) to generate detections and tracklets. Detections are per-frame outputs produced by object detector 222 (optionally served via serving service 224) over frames supplied by streamer 144. Each detection represents a localized instance of an object of interest (for example, a vehicle, person, or obstruction) and includes at least a bounding box or segmentation mask, an object class label, a confidence score, and optional appearance features or embeddings. Detections are tagged with frame/time indices, camera identifiers, and scene metadata so downstream components (such as multimodal model 226 and parking utilization engine 300) can filter, aggregate, and reason over them when generating metadata 310 and evaluating task constraints. Tracklets are temporally associated sequences of detections that represent the continuous trajectory of the same physical object across successive frames from a given camera stream. They are created by a data-association process that links detections frame-to-frame using motion models and/or appearance embeddings (e.g., Kalman filtering with assignment algorithms), and they maintain a persistent track ID, start/end timestamps, per-frame states (position, size, confidence), and derived kinematics (velocity, heading, dwell time). Tracklets enable robust counting, handoff through brief occlusions, and event inference by parking utilization engine 300 and multimodal model 226 under the task constraints provided by interface server 230 and rule creation engine 240. Multimodal model 226 evaluates these detections against the task constraints (e.g., zone identifiers, time window, and object attributes) and emits structured metadata 310 to parking utilization engine 300 indicating, for example but not limited hereto, current occupancy and any obstructed spaces. Parking utilization engine 300 parses the metadata to determine whether conditions satisfy an action trigger defined by the task (for example, obstruction detected in an available space or lot-at-capacity), and posts the resulting event and payload (camera ID, timestamp, affected zone/spot, confidence, and thumbnails) to event manager 270. Event manager 270 correlates the event with the natural language rule state, assigns a unique event identifier, and sets the appropriate action type (e.g., “update count,” “close barrier,” or “suspicious event”) consistent with the flow of FIG. 3.

Upon trigger, event manager 270 transmits an action message to interface server 230 for delivery to client 200 and, where configured, to site systems. Interface server 230 formats the message for GUI component 145 and GUI 390, attaching transport metadata and links to the underlying evidence (frame indices, camera identifiers, and cropped thumbnails), and sends the message over the authenticated channel maintained by communication component 142 to client 200 on end user device 210. GUI 390 renders the alert with the action type and contextual data (for example, the obstructed spot and confidence score) and prompts the operator for acknowledgement. In parallel, if the action requires site actuation (such as closing an entry barrier when the lot is full), interface server 230 forwards a control directive to the appropriate on-premises controller via communication component 142, and records acknowledgements and state transitions in database 250. This sequence is one, non-limiting example of performing the one or more actions—such as outputting the alert and optionally commanding barrier control—based on the natural language inputs and answers, with deterministic linkage to the analyzed video evidence.

In an alternative or additional aspect, the method 600 further includes identifying one or more objects in the plurality of images with a neural network.

In one example, which should not be construed as limiting, streamer 144 supplies batched frames from cameras 120-1, 120-2, . . . , 120-n to analytics component 143, which invokes object detector 222 via serving service 224. Serving service 224 performs inference preprocessing on each frame, including color space normalization, aspect-preserving resize with padding, and per-channel mean/variance normalization, and then dispatches the batch to a GPU-accelerated instance of a convolutional/transformer-based neural network 400. The neural network 400 executes a forward pass to produce per-region class logits and regressed bounding boxes (and optionally segmentation masks or keypoints), after which post-processing applies confidence thresholding and non-maximum suppression to yield final per-frame detections with class labels and confidence scores.

For each frame, the detections are annotated with the originating camera identifier, timestamp, and scene context carried by streamer 144 and are serialized as part of metadata 310 for downstream consumers. Where configured, embeddings from intermediate layers of the neural network 400 are exported with each detection to support short-term association into tracklets and to improve re-identification across occlusions. Parking utilization engine 300 consumes the metadata 310 to filter for object classes relevant to parking operations (for example, vehicles, cones, and pedestrians), and may invoke LPR 306 on vehicle detections to extract license plate text when permitted. Thus, this sequence provides one example of identifying one or more objects in the plurality of images with a neural network by executing object detector 222 under serving service 224 over frames delivered by streamer 144, producing normalized, de-duplicated detections that are time-and camera-aligned for subsequent reasoning by analytics component 143 and parking utilization engine 300.

In an alternative or additional aspect, the generating of the one or more natural language follow-up questions of the method 600 includes generating the one or more natural language follow-up questions based on a large-language model.

In one example, which should not be construed as limiting, rule creation engine 240 performs the generation using a large language model hosted within analytics component 143. Interface server 230 retrieves the current dialogue state and intent schema from database 250, along with scene context keys (e.g., active camera IDs, time window, venue type) obtained from streamer 144 and prior metadata 310, and supplies this material to rule creation engine 240. Rule creation engine 240 constructs an LLM input that includes: (i) a system prompt describing the task (produce follow-up questions that resolve low-confidence or missing slots), (ii) the normalized user input and any prior answers, (iii) the current intent schema with slot definitions and confidence scores, and (iv) context query candidates retrieved from context query store 260. The input further specifies a constrained output format (for example, a JSON schema enumerating question text, target slot identifiers, expected answer type, and optional choice sets), and decoding parameters (temperature, top-p) tuned to favor determinism.

The LLM executes to produce a set of candidate follow-up questions, each explicitly bound to one or more unresolved slots and annotated with the expected answer type and rationale. Rule creation engine 240 validates the LLM output against the declared schema, filters questions that are redundant with previously asked items recorded in database 250, and calls multimodal model 226 with sampled frames from streamer 144 to score each candidate's expected discriminative value under current scene conditions. Prompt engine 228 ranks the validated candidates using these scores and slot criticality, resolves any templated choices using entries from context query store 260 (for example, enumerating zone names or camera IDs), and serializes the top-ranked questions with per-question identifiers for persistence in database 250. Interface server 230 then packages the payload with session metadata for delivery to client 200, completing generation of the one or more natural language follow-up questions based on a large language model with schema-constrained decoding, context retrieval, and scene-aware ranking.

In an alternative or additional aspect, the method 600 further includes retrieving one or more context-based questions based on a context of the plurality of images.

In one example, which should not be construed as limiting, analytics component 143 derives a scene context key from recent frames and metadata 310 delivered by streamer 144, including active camera identifiers, site 102 attributes, time-of-day bucket, day-of-week, detected activity summaries from object detector 222 and multimodal model 226 (e.g., vehicle density, presence of cones or construction signage), and any currently active events from event manager 270. Interface server 230 packages these context features into a normalized context vector and issues a retrieval request to context query store 260 over an internal API that supports keyed lookups and similarity search. Context query store 260 maintains a versioned catalog of question templates indexed by discrete keys (e.g., venue type, camera zone, operating hours) and by learned embeddings for approximate nearest-neighbor retrieval; upon receiving the request, it performs a primary key match on the discrete fields and a secondary vector search on the embedding derived from the context vector to assemble a candidate set of context-based questions. Each candidate is returned with associated metadata, including applicable scopes (camera IDs or zones), required slot bindings, optional choice enumerations (e.g., zone names, entry gates), and confidence/ranking scores. Interface server 230 validates the payload, filters out templates already asked in the active session recorded in database 250, resolves dynamic enumerations against current site 102 configuration, and persists the resulting list to database 250 with a session identifier and template versioning for auditability. Rule creation engine 240 and prompt engine 228 then consume the stored list to condition generation of one or more natural language follow-up questions, ensuring that questions surfaced to client 200 are tailored to the current scene and reduce ambiguity without redundant dialogue.

In an alternative or additional aspect, the generating of the one or more natural language follow-up questions of the method 600 further includes generating the one or more natural language follow-up questions based on the context of the plurality of images.

In one example, which should not be construed as limiting, analytics component 143 derives a scene context vector from recent frames and metadata 310 delivered by streamer 144, including active camera identifiers from cameras 120-1, 120-2, . . . , 120-n, site 102 attributes, a time-of-day bucket, day-of-week, and activity summaries computed from object detector 222 and multimodal model 226 (for example, vehicle density, presence of construction cones, or lane closures). Interface server 230 packages these features and issues a retrieval to context query store 260, which maintains question templates indexed by discrete keys (e.g., venue type, camera zones) and by learned embeddings for similarity search. Context query store 260 returns a candidate set of context-aligned templates with associated scopes (camera IDs or zones), required slot bindings, and optional enumerations (e.g., zone names, entry gates). Interface server 230 filters out templates previously asked in the current session recorded in database 250 and resolves any dynamic enumerations against the current site 102 configuration.

Prompt engine 228 then instantiates the remaining templates into concrete follow-up questions by binding them to unresolved or low-confidence slots identified by rule creation engine 240 for the active task, and conditions each question on the current scene (for example, constraining area choices to cameras currently online or zones showing activity). Multimodal model 226 is optionally invoked on sampled frames from streamer 144 to estimate the discriminative value of each candidate under present conditions (e.g., expected reduction in hypothesis set size), and prompt engine 228 ranks the candidates accordingly. The top-ranked, context-conditioned questions are serialized with per-question identifiers, target slot identifiers, expected answer types, and any resolved choice sets, and are persisted to database 250 for delivery, thereby generating the one or more natural language follow-up questions based on the context of the plurality of images.

In an alternative or additional aspect, the performing of the one or more actions of the method 600 further includes performing one or more of determining a number of vacant spots in the parking facility, determining an obstruction in a spot of the parking facility, determining a suspected event in the parking facility, or identifying one or more drivers of one or more vehicles in the parking facility.

In one example, which should not be construed as limiting, streamer 144 supplies time-aligned frames from cameras 120-1, 120-2, . . . , 120-n to analytics component 143. Object detector 222 (served via serving service 224) produces per-frame detections and tracklets for vehicles and pedestrians, and multimodal model 226 fuses these with site 102 geometry to emit metadata 310 that includes per-spot occupancy states, object attributes, and dwell-time statistics. Parking utilization engine 300 ingests metadata 310 and a stall map from rules and configurations store 350 to evaluate each delineated parking spot: a spot is marked vacant when no vehicle-class detection with sufficient intersection-over-union to the spot polygon persists over a minimum temporal window. Otherwise the spot is marked occupied. Counts of vacant and occupied spots are aggregated per zone and for the facility, and the results are posted to event manager 270 with camera identifiers, timestamps, and confidence measures for rendering in GUI 390.

To determine an obstruction in a spot, parking utilization engine 300 filters metadata 310 for non-vehicle objects (e.g., cones, debris, carts) whose masks or bounding boxes overlap a spot polygon beyond a configurable threshold and whose tracklets persist longer than a transient cutoff. Multimodal model 226 cross-checks recent frames for lane-closure signage or adjacent vehicle encroachment to disambiguate temporary occlusions from true obstructions. When an obstruction condition is met, event manager 270 creates an “update count” or “obstruction” event with thumbnails, affected spot/zone identifiers, and confidence, and transmits the action message via interface server 230 to client 200 for display in GUI 390.

To determine a suspected event, analytics component 143 evaluates rule conditions defined via the natural language dialogue and stored in database 250, such as abnormal dwell time near a vehicle, repeated door-handle interactions, or sudden motion patterns indicative of a collision. Tracklets derived from detections are analyzed for kinematic anomalies (e.g., abrupt deceleration and contact between two vehicle tracks) and interaction graphs between person and vehicle tracks. When conditions satisfy a suspected-event rule, parking utilization engine 300 emits a structured incident record within metadata 310, and event manager 270 correlates the structured incident record to the active natural language rule and issues a “suspicious event” action to GUI 390 along with linked evidence (frame indices, camera IDs, cropped thumbnails).

To identify one or more drivers of one or more vehicles, analytics component 143 associates person tracklets with vehicle tracklets using spatiotemporal proximity at ingress/egress points and door-open events inferred from pose or door-edge appearance changes. Where permitted, LPR 306 is invoked on vehicle detections to extract license plate text, and the association between a person tracklet and a vehicle tracklet is recorded with timestamps and confidence in database 250. Parking utilization engine 300 outputs driver-vehicle association metadata to event manager 270, which generates an “identify driver” action containing the camera identifier, time window, associated spot or zone, and evidence thumbnails, for presentation to client 200 through interface server 230 and GUI 390.

Therefore, in general, the present disclosure provides systems and methods for monitoring and/or optimizing parking site management by leveraging natural language processing in conjunction with image-based data acquisition. The present disclosure enables a user to submit a natural language question regarding the status or management of a parking facility, wherein the system automatically receives and analyzes a plurality of images from distributed cameras, processes the visual data to extract relevant information, and generates a responsive output tailored to the user's query. This approach offers significant technical advantages over prior solutions, including the ability to dynamically interpret and respond to complex, context-specific questions without requiring pre-defined query structures, as well as improved accuracy and efficiency in parking management through real-time, automated analysis of visual data. The integration of natural language understanding with image analytics provides a more intuitive and flexible interface for users, reduces manual intervention, and enhances the overall responsiveness and scalability of parking facility operations.

It will be appreciated that various implementations of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

What is claimed is:

1. A system for parking site management, comprising:
one or more memories storing instructions therein;
one or more processors communicatively coupled with the one or more memories and configured, individually or in any combination, to:
receive a plurality of images of a parking facility;
receive one or more natural language inputs from a client for operating the parking facility;
generate one or more natural language follow-up questions based on the one or more natural language inputs;
provide the one or more natural language follow-up questions to the client;
receive, in response to the one or more natural language follow-up questions, one or more natural language answers; and
perform one or more actions associated with the parking facility based on at least one of the one or more natural language inputs and at least one of the one or more natural language answers.

2. The system of claim 1, wherein the one or more processors are further configured to identify one or more objects in the plurality of images with a neural network.

3. The system of claim 1, wherein to generate the one or more natural language follow-up questions the one or more processors are further configured to iteratively generate the one or more natural language follow-up questions based on a large-language model.

4. The system of claim 1, wherein the one or more processors are further configured to retrieve one or more context-based questions based on a context of the plurality of images.

5. The system of claim 4, wherein to generate the one or more natural language follow-up questions the one or more processors are further configured to iteratively generate the one or more natural language follow-up questions based on the context of the plurality of images.

6. The system of claim 1, wherein to perform the one or more actions the one or more processors are further configured to perform one or more of determining a number of vacant spots in the parking facility, determining an obstruction in a spot of the parking facility, determining a suspected event in the parking facility, or identifying one or more drivers of one or more vehicles in the parking facility.

7. A non-transitory computer readable medium having instructions stored therein for parking site management, the instructions, when executed by one or more processors, individually or in any combination, cause the one or more processors to:
receive a plurality of images of a parking facility;
receive one or more natural language inputs from a client for operating the parking facility;
generate one or more natural language follow-up questions based on the one or more natural language inputs;
provide the one or more natural language follow-up questions to the client;
receive, in response to the one or more natural language follow-up questions, one or more natural language answers; and
perform one or more actions associated with the parking facility based on the one or more natural language inputs and the one or more natural language answers.

8. The non-transitory computer readable medium of claim 7, wherein the instructions further cause the one or more processors to identify one or more objects in the plurality of images with a neural network.

9. The non-transitory computer readable medium of claim 7, wherein to generate the one or more natural language follow-up questions the instructions further cause the one or more processors to iteratively generate the one or more natural language follow-up questions based on a large-language model.

10. The non-transitory computer readable medium of claim 7, wherein the instructions further cause the one or more processors to retrieve one or more context-based questions based on a context of the plurality of images.

11. The non-transitory computer readable medium of claim 10, wherein to generate the one or more natural language follow-up questions the instructions further cause the one or more processors to iteratively generate one or more natural language follow-up questions based on the context of the plurality of images.

12. The non-transitory computer readable medium of claim 7, wherein to perform the one or more actions the instructions further cause the one or more processors to perform one or more of determining a number of vacant spots in the parking facility, determining an obstruction in a spot of the parking facility, determining a suspected event in the parking facility, or identifying one or more drivers of one or more vehicles in the parking facility.

13. A method for parking site management, comprising:
receiving a plurality of images of a parking facility;
receiving one or more natural language inputs from a client for operating the parking facility;
generating one or more natural language follow-up questions based on the one or more natural language inputs;
providing the one or more natural language follow-up questions to the client;
receiving, in response to the one or more natural language follow-up questions, one or more natural language answers; and
performing one or more actions associated with the parking facility based on the one or more natural language inputs and the one or more natural language answers.

14. The method of claim 13, further comprising identifying one or more objects in the plurality of images with a neural network.

15. The method of claim 13, wherein generating the one or more natural language follow-up questions comprises iteratively generating the one or more natural language follow-up questions based on a large-language model.

16. The method of claim 13, further comprising retrieving one or more context-based questions based on a context of the plurality of images.

17. The method of claim 16, wherein generating the one or more natural language follow-up questions comprises iteratively generating the one or more natural language follow-up questions based on the context of the plurality of images.

18. The method of claim 13, wherein performing the one or more actions comprises performing one or more of determining a number of vacant spots in the parking facility, determining an obstruction in a spot of the parking facility, determining a suspected event in the parking facility, or identifying one or more drivers of one or more vehicles in the parking facility.

19. The method of claim 13, wherein performing the one or more actions comprises triggering an alarm in a graphical user interface for display to an operator in response to one of determining the parking facility is full, determining the parking facility is closed, determining the parking facility is unsafe for use, or determining a suspected event in the parking facility.

20. The method of claim 13, wherein performing the one or more actions comprises forwarding a control directive to a controller at the parking facility to actuate closing of an entry barrier to the parking facility in response to one of determining the parking facility is full, determining the parking facility is closed, or determining the parking facility is unsafe for use.
